(19) United States
(12) Patent Application Publication
(10) Pub. No.: US 2006/0284788 A1
(43) Pub. Date: Dec. 21, 2006

(54) Infinity tunnel display system with floating dynamic image

(76) Inventors: Douglas L. Robinson, Ithaca, NY (US); Kenneth S. Westort, Ithaca, NY (US); Randolph J. Turner, Ithaca, NY (US)

Correspondence Address: AQUILLA PATENTS & MARKS, PLLC, 221 COE HILL ROAD, CENTER HARBOR, NH, 03326-3605, US

(21) Appl. No.: 11/157,420

(22) Filed: Jun. 21, 2005

(51) Int. Cl. G09G 5/00

(52) U.S. Cl. 345/3.1

(57) ABSTRACT

An optical display apparatus includes a housing, a partially reflective front window or beamsplitter having a front side forming a face of the housing, wherein the front window or beamsplitter appears transparent from the face of the housing and is at least partially reflective to light coming from within said housing, a mirror of glass, plastic, stretched mirror-coated thermoplastic film or other reflective substrate, located within the housing and positioned at a predetermined distance behind the front window or beamsplitter, a plurality of LEDs arranged proximate to the mirror, such that light is transmitted from the mirror to a rear side of the front window or beamsplitter, a LCD monitor or CRT or other display device or screen positioned and near coincident to the rear side of the front window or beamsplitter, and a circuit for controlling the LEDs.

### BACKGROUND OF THE INVENTION

1. Field of the Invention

The invention pertains to the field of optical display systems. More particularly, the invention pertains to methods and apparatus for creating an illusion, in an optical display actually having a relatively shallow depth, of a tunnel having infinite depth with a moving image floating in the center of the tunnel.

2. Description of Related Art

The so-called “infinity tunnel” is a device based on simple principles of optics, generally comprising a series of reflectors and lights, which are arranged to create the illusion of a never-ending tunnel of lights. The infinity tunnel was developed as a novelty item in the 1930s and was later embraced by the popular culture of the 1970s, coincident with the availability of semi-reflective architectural glass, which functions as a partially mirrored window or beamsplitter. The infinity tunnel typically was incorporated into clocks, wall mirrors and novelty gifts, and various improvements and modifications have been developed.

U.S. Pat. No. 5,787,618 discloses a display device for forming an optical illusion having an interior area in which multiple images are displayed. The images arise from reflections of one or more externally or internally illuminated patterns located within the apparatus. The device creates an optical illusion whereby multiple images appear to extend a rearward distance that is greater than the thickness of the apparatus. When multiple patterns are employed, the patterns may be spaced from each other and are combined to form the desired image. The apparatus may include one or more spotlights that function to highlight predetermined area(s) within the device. The apparatus may alternatively or in combination employ an isolated light source that illuminates the interior of a light transmitting object located between the reflective surfaces to thereby cause the object and especially the object's side edges to glow with light. In addition, recessed lighting fixtures may be employed to illuminate the interior area of the device in a manner whereby the lighting fixtures are not readily viewable from a location exterior to the device

U.S. Pat. No. 5,951,143 discloses an infinity-projecting light assembly that is housed in an enclosure that encloses a multiplicity of lamps and passive components. Within the enclosure is located a convex mirror that is attached to the enclosure's rear panel and a two-way mirror that is attached to the front ledge of the enclosure. The mirrored surfaces of the two mirrors face each other which allows the lamps and passive components to be replicated into a descending visual tunnel that terminates at a perceived infinity point. The assembly incorporates an electrical-control circuit that provides the power to light the interior of the enclosure via a decorative translucent panel. The circuit also provides power to a music playback unit, the lamps, a light dimming unit and a light blinking unit. The light blinking unit can be set to blink in synchrony with the music from the playback unit.

U.S. Pat. No. 4,164,823 discloses a luminous effects device including a partially silvered mirror, a frusto-conical reflector having a plurality of lights disposed about its inner periphery and a spherical reflector, all of which are disposed within a closed container and aligned in series so that multiple reflections occur between the partially silvered mirror, frusto-conical reflector and spherical reflector to create an endless tunnel effect that can be viewed through the opposite side of the partially silvered mirror.

U.S. Pat. No. 3,736,832 discloses a light display apparatus comprising a plurality of light sources controlled by circuitry and a display screen. The display apparatus can project images onto the screen in several relative positions to create apparent motion in coordination with a sound wave signal.

U.S. Pat. No. 3,610,918 discloses a novelty-type light device, which includes a generally hollow body mounted on a support means and within which is a light source. The hollow body is defined by a plurality of generally planar panels angularly oriented relative to each other. The panels are semi-reflective or at least semi-transparent, whereby when the light source is viewed through any one of the panels, a reflection of the light source is seen on one or more of the other panels through said one section to provide multiple reflections to give an “infinity” effect.

U.S. Pat. Nos. 2,286,247, 2,286,246, 2,222,301, and 2,221,889 disclose various similar devices commonly referred to as an “infinity tunnel”.

### SUMMARY OF THE INVENTION

The present invention provides methods and apparatus for creating an illusion, in an optical display actually having a relatively shallow depth, of a tunnel having infinite depth with a moving image floating in the center of the tunnel. According to a preferred aspect of the present invention, herein is disclosed an optical display apparatus comprising a housing, a partially reflective front window or beamsplitter having a front side forming a face of the housing, wherein the front window or beamsplitter appears transparent from the face of the housing and is at least partially reflective to light coming from within said housing, a mirror of glass, plastic, stretched mirror-coated thermoplastic film, or other reflective substrate, located within the housing and positioned at a predetermined distance behind the front window or beamsplitter, a plurality of Light Emitting Diodes (LEDs) arranged proximate to the mirror, such that light is transmitted from the mirror to a rear side of the front window or beamsplitter, a circuit for controlling the LEDs, and a Liquid Crystal Display (LCD) monitor or Cathode Ray Tube (CRT) monitor or other display device or screen positioned and near coincident to the rear side of the front window or beamsplitter.

According to another preferred aspect of the present invention, herein is disclosed an optical display actually having a relatively shallow depth, of a tunnel having infinite depth with a moving image floating in the center of the tunnel. According to a preferred aspect of the present invention, herein is disclosed an optical display apparatus comprising a housing, a partially reflective front window or beamsplitter having a front side forming a face of the housing, wherein the front window or beamsplitter appears transparent from the face of the housing and is at least partially reflective to light coming from within said housing, a mirror of glass, plastic, stretched mirror-coated thermoplastic film or other reflective substrate, located within the housing and positioned at a predetermined distance behind the front window or beamsplitter, a plurality of LEDs arranged proximate to the mirror, such that light is transmitted from the mirror to a rear side of the front window or beamsplitter, a circuit for controlling the LEDs, a LCD monitor or CRT or other display device or screen positioned and near coincident to the rear side of the front window or beamsplitter, and a real image projection system mounted behind the front window or beamsplitter, projecting a real image through the beamsplitter and forming a floating image in free space in front of the beamsplitter.

An advantage of the present invention is that it provides a moving image within the infinity tunnel and creates the illusion of a floating three-dimensional image. Additionally, prior art infinity tunnel systems typically incorporate incandescent light bulbs mounted in front of the mirror from the sides of the enclosure. The present invention incorporates LEDs that preferably protrude through the mirror. The LEDs typically have a life of approximately eleven years, as opposed to less than one year for incandescent lights. LEDs produce no heat, and the light of a LED is focused in a cone pattern toward the beamsplitter, rather than in all directions, as in the case of an incandescent bulb. The result is less stray light inside the system, a brighter, crisper light image pattern, less maintenance, with no heat, and longer life.

These and other features and advantages will become readily apparent from the following Detailed Description, which should be read in conjunction with the accompanying drawing figures.

### BRIEF DESCRIPTION OF THE DRAWING

FIG. 1 shows the general visual effect produced by one embodiment according to the invention.

FIG. 2 shows the relationship of the components positioned within one embodiment according to the invention.

FIG. 3 shows a second embodiment according to the invention, including an oval design incorporating a LED scrolling text display.

FIG. 4 shows a typical LED mounting circuit board with its control circuit elements.

FIG. 5 shows a method for oscillating the lighting pattern using a speaker and low frequency modulation, according to an embodiment of the invention.

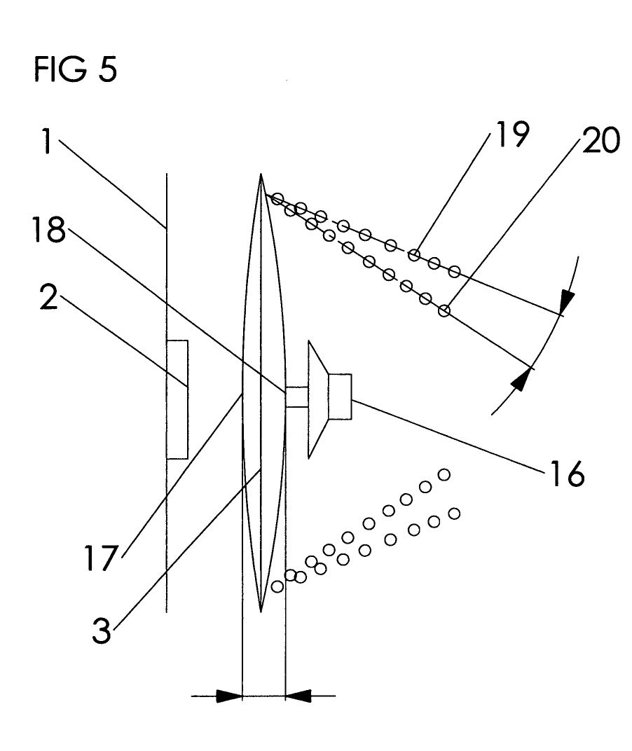

FIG. 6 shows an alternative embodiment according to the invention, including a real image projection system installed in place of a LCD panel.

### DETAILED DESCRIPTION OF THE INVENTION

The present invention provides methods and apparatus for creating an illusion, in an optical display actually having a relatively shallow depth, of a tunnel having infinite depth a moving image floating in the center of the tunnel.

In a preferred embodiment, device incorporates a mirror and beamsplitter and a series of LEDs to create multiple images of the series of LEDs, which seem to appear in an infinite number of layers extending back into the display. The system further incorporates a LCD mounted between the front beamsplitter and the rear reflective mirror. The partially reflective front beamsplitter preferably hides the frame or housing of the LCD panel, making it nearly invisible from the front viewing position. The image produced on the LCD screen is visible through the beamsplitter, from the front of the device. In one embodiment, the image on the LCD shows bright colorful moving objects, rendered with shading to create the visual cue of a three-dimensional object, while the surrounding screen area appears black. The result to the viewer is a three-dimensional moving object floating in free space. The viewer sees an infinitely deep tunnel of lights with a 3D moving object floating in the front center of the tunnel.

The infinity tunnel function of the device is useful as an attractor to the 3D message presented on the LCD screen. Examples of the device's use include, for example, such applications as presenting movie trailers, or displaying products and advertising in a 3D format. A significant advantage of the invention is that the image produced appears to be five to six feet deep, while in reality it is only five to six inches deep, thus creating a significant “attention-getter” or attraction for getting a message across to the viewer. This is a significant advantage, particularly when space is a constraint. Another advantage is that with the use of wide-view LCD panels, the field of view can be over 120 degrees, offering a significant advantage over prior art real image projection systems.

In one embodiment according to the invention, the apparatus incorporates a partially reflective front window (1) or beamsplitter, a reflective mirror (3), an array of LED Lights (4), a LCD Monitor (2), and an enclosure (5). The front window preferably is an optically coated beamsplitter or reflective architectural glass, such as Eclipse glass, or a plastic substrate coated with a partially reflective optical coating. The beamsplitter optionally is of a configuration other than flat, such as spherical, or toroidal in surface configuration. The distance between the mirror and beamsplitter controls the distance between each layer of reflections. The distance may be varied as desired. The mirror should normally be parallel with the beamsplitter, however mounting at an angle will allow the reflected tunnel image to angle upward or downward, depending on the desired view angle. The mirror optionally is of a configuration other than flat, such as spherical, or toroidal in surface configuration. The mirror optionally is plastic, glass or any other reflective substrate, including stretched mirror-coated thermoplastic film, such as Mylar® brand polyester film, made by DuPont Teijin Film, for example.

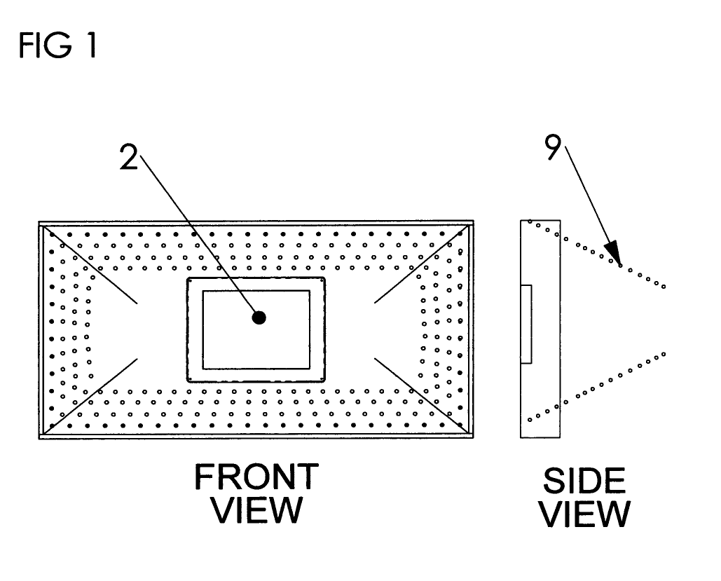

Referring now to FIG. 1, the general visual effect produced by one embodiment according to the invention is shown. The LCD panel (2) displays an image preferably with visual cues, such as shading, which creates a 3D effect. The screen area around the 3D object displayed preferably is black to give the appearance of the object floating on a black background. The LCD enclosure and the black image background are not visible through the partially transmissive front window, so only the 3D bright and moving portion of the image is visible through the front window. The single outer ring of LEDs or multiple rings of LEDs reflect between the front beamsplitter window and the inner mirror, creating an infinite number of rings of LEDs (9) extending back into the display. This gives the illusion of extreme depth.

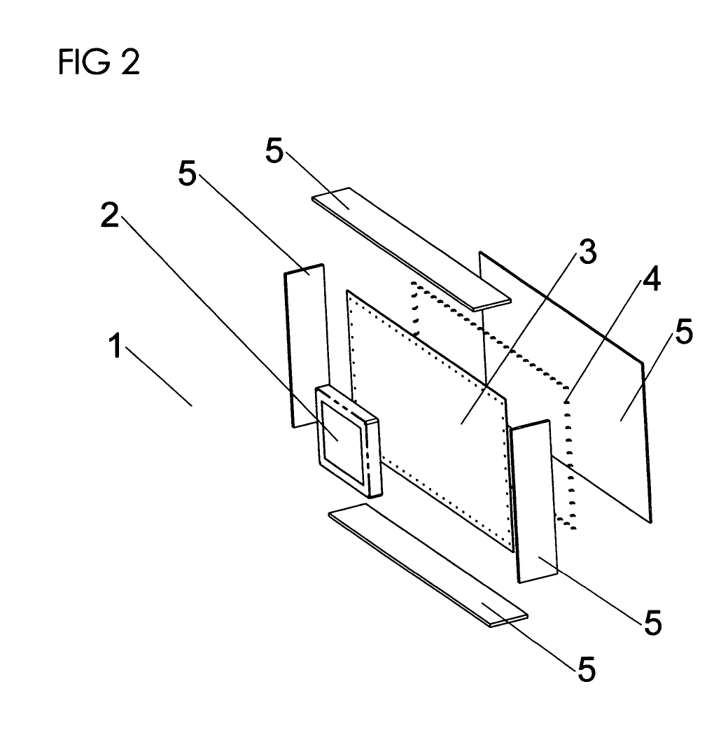

Referring now to FIG. 2, the arrangement of the components within one embodiment according to the invention is shown. The front window or partially reflective mirror (1) reflects the light from the LEDs (4) back onto the rear mirror (3), which then reflects back onto the beamsplitter (1), and then back onto the mirror (3), and back to the beamsplitter (1), continuing an infinite number of times. Since the front beamsplitter is partially reflective, a portion of the light will pass through, being visible to the viewer, thus enabling the viewer to see a greater number of rings of light, with each layer appearing deeper into the tunnel. The LEDs preferably are mounted behind the mirror and inserted through holes in the mirror, being visible from the front of the mirror. The LEDs can be any color that is available, including multicolor, and may be positioned in any pattern. In an alternative embodiment, the LED light is visible through clear, non-reflective areas on the mirror surface, and the LEDs are mounted behind these circular clear areas. The clear areas must be of acceptable size and shape to allow the LEDs' cone of light to transmit through the aperture.

A LCD panel (2) is positioned at the center rear surface of the front beamsplitter window (1). The LCD image (2) is created with the bright moving object, such as a can of soda rotating, with the surrounding area being black. Since the black screen area has virtually no light emitted, it is not visible through the front beamsplitter window, therefore only the image of bright colored object is transmitted, visible to the viewer. Since the elements (2,3,4) are enclosed in a case (5), no light from outside enters the system, so the frame or enclosure of the LCD panel (2) is not visible through the partially transmissive beamsplitter window (1). The LCD panel should be placed at near center of the beamsplitter, though positioning may be altered based on desired viewer position. The LCD screen must be positioned at or close enough to the beamsplitter rear surface so that light from the LCD screen is not reflected back to the mirror surface. The image can be generated by a video player, computer or any device capable of outputting a video signal to the LCD. The display device optionally is a plasma display, CRT or any other display that will fit between the beamsplitter and mirror. If the video display is a CRT, a clearance hole can be cut into the mirror to allow the rear of the CRT to protrude.

The visual effect to the viewer is a brightly lit 3D image floating in the center of a tunnel of lights of infinite depth. By creating the video image so that it appear to zoom in and out, the illusion of a floating 3D object is significantly enhanced.

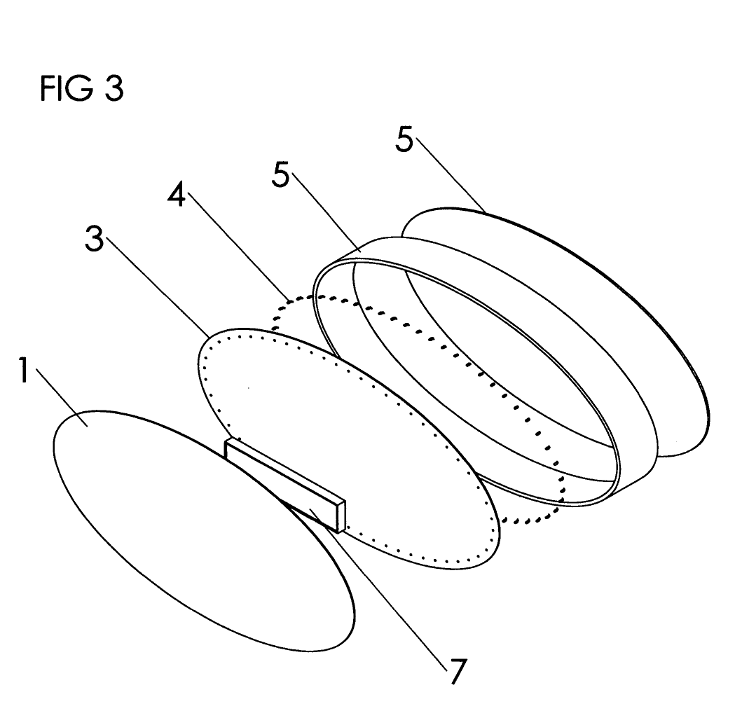

Referring now to FIG. 3, an alternate embodiment of the invention is shown. The LED pattern optionally is oval, rectangular, round, or of any pattern. A programmable LED sign (7) optionally is incorporated with the LCD, or in place of the LCD panel, scrolling text messages and designs floating at the center of the tunnel. The components (1,3,4) are positioned as those shown in FIG. 2.

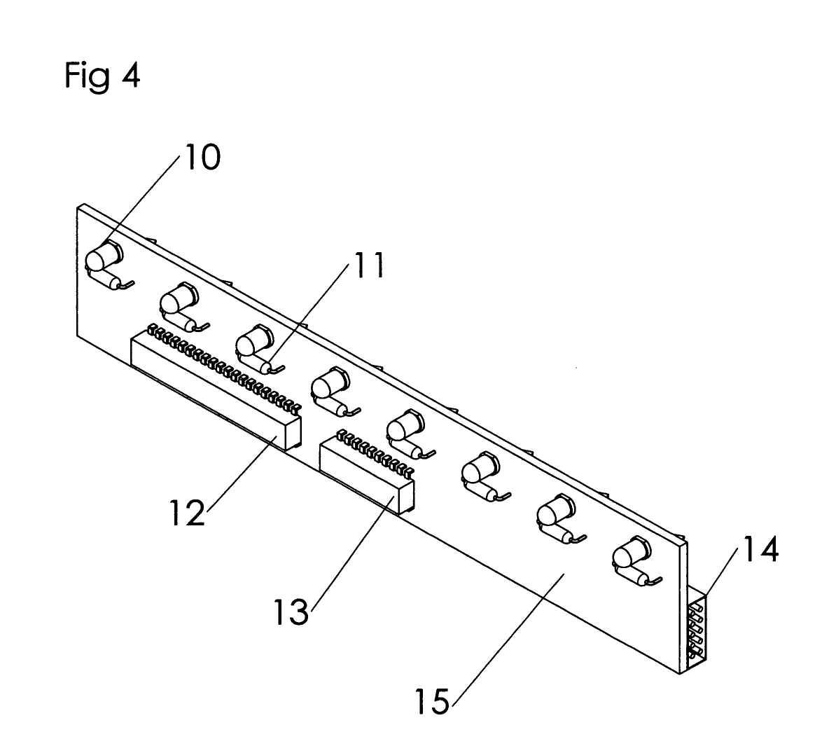

Referring now to FIG. 4, an alternate embodiment of the invention is shown, including an example of a LED Mounting Module. The LED bulbs (10) are positioned equally spaced on the PC board (15), and resistors (11) are incorporated to limit current draw of the LEDs (10). An 8-resistor array chip optionally is used. A LED Driver chip (13) drives the eight LEDs (10) on the PC board (15). In a full system, several of the LED boards optionally are connected together with connectors (14) to form the full array. Preferably, one of the boards includes a microprocessor chip (12), which controls the driver chips (13) mounted on each individual board. Brightness of the LEDs can be controlled through pulse width modulation. Various lighting sequence software programs can be stored within the microprocessor RAM, which can be accessed by an external switch.

The microprocessor chip contains software programs that control the sequencing on the LEDs to create various effects, such as lights spiraling into the background, etc The microprocessor programs may be selected by an optional multi-position rotary switch located on the side of the display device, for example.

Referring now to FIG. 4, a method for dynamically changing the pattern and depth of the tunnel effect is shown. An electromagnetic pulse device or speaker (16) is mounted behind and attached to the rear mirror (3), and by pulsing low frequency signals to the speaker (16), the mirror (3) will flex (17,18) and the light reflection pattern (19,20) will move. The pulse can be synched to music, for example, or a video presentation. Other electrical or mechanical devices that accomplish the task of flexing or bowing the mirror or beamsplitter can be used as well. The goal is to distort the reflected light path of the LEDs, thus causing the reflected images to move or their positions to pulse.

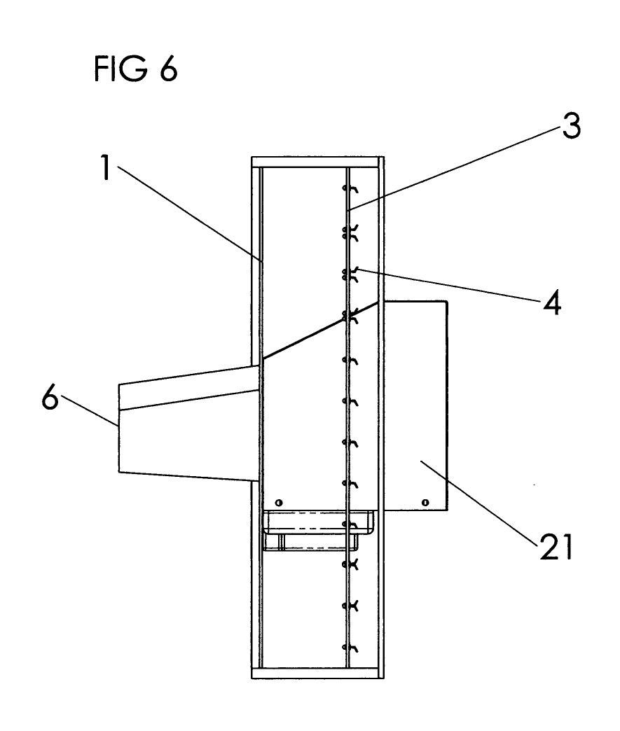

Referring now to FIG. 6, another embodiment according to the invention is shown, including a real image projection display (21) mounted inside the infinity tunnel with the face of the projector installed against the rear surface of the front beamsplitter (1). The rear of the real image projector (21) extends back through an opening in the rear mirror (3). The real image projector forms an image (6) floating in front of the beamsplitter (1) in free space. The resulting view for the observer is a floating 3D image (6) suspended approximately 6-8″ in front of the beamsplitter (1), surrounded by multiple images of the ring patterns of LED light (4) images extending back past the rear of the device.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An optical display apparatus, comprising:
a) a housing;
b) a partially reflective front window or beamsplitter having a front side forming a face of said housing, wherein said front window or beamsplitter appears transparent from said face of said housing, and is at least partially reflective to light coming from within said housing;
b) a mirror of glass, plastic, stretched mirror-coated thermoplastic film or other reflective substrate, located within said housing and positioned at a predetermined distance behind said front window or beamsplitter;
c) a plurality of LEDs arranged proximate to said mirror, such that light is transmitted from said mirror to a rear side of said front window or beamsplitter;
d) a LCD monitor or CRT or other display device or screen positioned and near coincident to said rear side of said front window or beamsplitter; and
e) a circuit means for controlling said LEDs.

2. The optical display apparatus of claim 1, wherein said mirror comprises a surface that is substantially flat or planar, spherical, or toroidal.

3. The optical display apparatus of claim 2, wherein said mirror is positioned at a distance of about one to three inches from said beamsplitter.

4. The optical display apparatus of claim 1, wherein said beamsplitter or front window comprises an optically coated beamsplitter or reflective architectural glass, and wherein a reflective surface of said beamsplitter or front window faces toward an inside of said display apparatus enclosure or opposite a viewer of said display.

5. The optical display apparatus of claim 4, wherein said beamsplitter or front window is characterized by a transmission/reflection of about 50%/50%.

6. The optical display apparatus of claim 1, further comprising a plurality of LEDs arranged to be visible from a front side of said mirror.

7. The optical display apparatus of claim 6, wherein said LEDs are mounted behind said mirror and visible through clear, non-reflective areas on said mirror surface.

8. The optical display apparatus of claim 6, further comprising a control circuit incorporating a microprocessor for controlling lighting sequences and brightness of said LEDs.

9. The optical display apparatus of claim 8, wherein LED control is accomplished by a computer or external CPU.

10. The optical display apparatus of claim 1, further comprising a LCD video screen, plasma display, CRT or any other display screen that fits between said beamsplitter and mirror positioned at said rear surface of said front window or beamsplitter, and a viewing surface of said display screen faces a viewer of said display apparatus.

11. The optical display apparatus of claim 10, wherein said display screen is positioned at near center of said beamsplitter, and at or near coincident to said beamsplitter rear surface, such that light from said display screen is not reflected back to said mirror surface.

12. The optical display apparatus of claim 11, wherein said display screen presents an image including brightly lit subjects or objects surrounded by a black background, and said object(s) is rendered with shading and/or visual cues to create the illusion of a three-dimensional image.

13. The optical display apparatus of claim 12, wherein said image is generated by a video player, computer or any device capable of outputting a video signal to the LCD.

14. The optical display apparatus of claim 11, wherein said display screen presents an image that does not include rendered graphics and/or fills the entire screen.

15. The optical display apparatus of claim 10, wherein said display screen comprises a LED scrolling sign to display scrolling LED patterns or text messages.

16. The optical display apparatus of claim 1, further comprising electrical or mechanical means for causing said front window or beamsplitter surface or said mirror surface to become convex or concave or otherwise move.

17. The optical display apparatus of claim 16, wherein said electrical or mechanical means comprises a speaker or electromagnetic device for generating an acoustical pressure wave to flex said mirror when low frequency signals are sent to said speaker or electromagnetic device, or wherein said electrical or mechanical means comprises any other electrical or mechanical means operatively connected to said front window or beamsplitter or said mirror for flexing or moving said front window or beamsplitter or said mirror, upon being activated by a control signal or in a timed sequence, causing a LED light pattern to change based on the control signal strength and sequence.

18. The optical display apparatus of claim 17, wherein said electrical or mechanical means causes said mirror to flex, bow, or move upon being activated by a control signal, or in a timed sequence, thus causing said LED image pattern to shift or pulse.

19. The optical display apparatus of claim 17, wherein said electrical or mechanical means causes said front window or beamsplitter to flex, bow, or move upon being activated by a control signal, or in a timed sequence, thus causing said LED image pattern to shift or pulse.

20. The optical display apparatus of claim 1, further comprising a real image projection system mounted behind said front window or beamsplitter, projecting a real image through said beamsplitter and forming a floating image in free space in front of said beamsplitter.
